(19) United States
(12) Patent Application Publication
(10) Pub. No.: US 2010/0135598 A1
(43) Pub. Date: Jun. 3, 2010

(54) Systems and Methods for Managing Production of Graphical Objects

(76) Inventors: Shawna Olwen, Huntsville, AL (US); Marion Bennett Perritt, Madison, AL (US)

Correspondence Address: LANIER FORD SHAVER & PAYNE P.C., P O BOX 2087, HUNTSVILLE, AL, 35804-2087, US

(21) Appl. No.: 12/628,904

(22) Filed: Dec. 1, 2009

Related U.S. Application Data
(63) Continuation-in-part of application No. PCT/US2008/065482, filed on Jun. 2, 2008.
(60) Provisional application No. 60/941,545, filed on Jun. 1, 2007.
(60) Provisional application No. 61/118,915, filed on Dec. 1, 2008.

(51) Int. Cl. G06K 9/54

(52) U.S. Cl. 382/306

(57) ABSTRACT

A graphical object management system enables clients to easily and efficiently find and utilize graphical artists interested in drawing or otherwise creating graphical objects for the clients. Once a graphical artist for creating a graphical object is located and selected, the system manages the graphical object as it is being created allowing the client to view the graphical object and provide feedback to the selected artist. In one embodiment, the system prevents the selected artist from making illicit copies of the graphical object being created.

### CROSS REFERENCE TO RELATED APPLICATIONS

This application is a continuation-in-part of International Application Serial No. PCT/US2008/065482 entitled “Systems and Methods for Managing Production of Graphical Objects,” and filed on Jun. 2, 2008 which claims the benefit of U.S. Provisional Patent Application No. 60/941,545, entitled “Systems and Methods for Managing Production of Graphical Objects,” and filed on Jun. 1, 2007. This application also claims the benefit of U.S. Provisional Patent Application No. 61/118,915, entitled “Systems and Methods for Managing Production of Graphical Objects,” and filed on Dec. 1, 2008. Each of the foregoing patent applications is incorporated herein by reference.

### RELATED ART

Graphical artists are often employed to create graphical objects for use in a variety of applications, such as films, animation, video games, and television programs. The demand for the services of graphical artists can drastically fluctuate for a production studio or other entity depending on the types of projects being handled by such entity. For example, during the production of an animated movie, a production studio may require significant services from graphical artists, but such demand may dissipate once the movie has been completed.

Moreover, many entities, such as production studios, find it desirable to outsource the services of graphical artists. However, graphical artists are located throughout the world and often having varying levels of skill and experience. Locating and assessing the talents of suitable graphical artists can be burdensome and problematic.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a system for managing production of graphical objects.

FIG. 2 is a block diagram illustrating an exemplary embodiment of a server, such as is depicted in FIG. 1.

FIG. 3 is a block diagram illustrating an exemplary embodiment of an artist system, such as is depicted in FIG. 1.

FIG. 4 is a block diagram illustrating an exemplary embodiment of a client system, such as id depicted in FIG. 1.

FIG. 5 illustrates an exemplary web page displayed in response to a client query in a system for managing production of graphical objects, such as is depicted by FIG. 1.

FIG. 6 illustrates an exemplary quick view page displayed by a system for managing production of graphical object, such as is depicted by FIG. 1.

FIG. 7 illustrates an exemplary display of misaligned perspectives of a graphical object.

FIG. 8 illustrates an exemplary display of the perspectives of FIG. 7 after alignment by an alignment tool within a system for managing production of graphical objects, such as is depicted by FIG. 1.

### DETAILED DESCRIPTION

In a variety of situations, a client may be interested in creating one or more graphical objects. For example, a movie company may desire for an artist to draw or otherwise create a graphical object representing a character or other type of object to be rendered in an upcoming movie. In another example, a software developer may desire for an artist to draw or otherwise create a graphical object to be rendered in computer game or other type of software product. There are various other situations when it may desirable for a client to seek the services of a graphical artist.

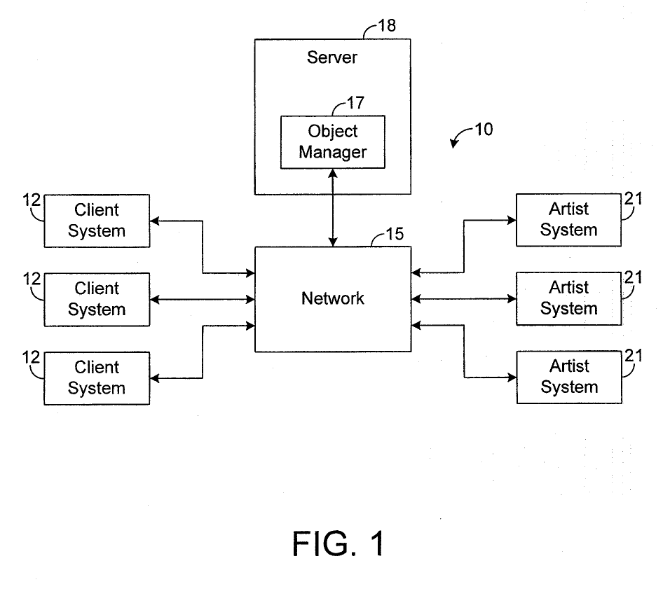

In at least one exemplary embodiment, a graphics management service is provided that allows clients to find and utilize graphical artists interested in drawing or otherwise creating graphical objects for the clients. FIG. 1 depicts an exemplary graphical object management system 10 in accordance with an exemplary embodiment of the present disclosure. The system 10 comprises a plurality of client systems 12 that are communicatively coupled to a network 15. In one exemplary embodiment, the network 15 is a wide area network (WAN), such as the Internet for example, although other types of networks may be employed in other embodiments. A server 18 and a plurality of artist systems 21 are also communicatively coupled to the network 15.

Each client system 12 may be respectively implemented as one or more computer systems, such as a desk-top computer, a lap-top computer, a personal digital assistant (PDA), and/or any other type of known computer system. In addition, each artist system 21 may be respectively implemented as one or more computer systems, such as a desk-top computer, a lap-top computer, a personal digital assistant (PDA), and/or any other type of known computer system. For illustrative purposes, it will be assumed hereafter that each client system 12 is associated with and used by a respective client and that each artist system 21 is associated with and used by a respective artist. However, it is possible for more than one client to use the same client system 12, and it is possible for more than one artist to use the same artist system 21, if desired.

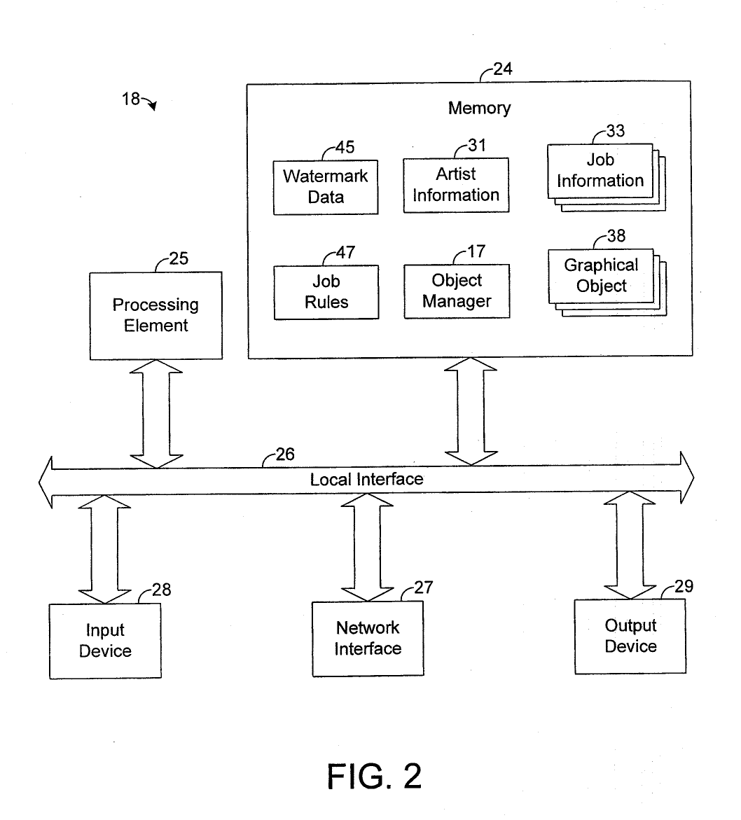

FIG. 2 depicts a more detailed view of the server 18 in accordance with one embodiment of the present disclosure. As shown by FIG. 2, the server 18 comprises an object manager 17, which can be implemented in software, firmware, hardware, or any combination thereof. In the exemplary embodiment depicted by FIG. 2, the object manager 17 is implemented in software and stored in memory 24.

Note that the object manager 24, when implemented in software, can be stored and transported on any computer-readable medium for use by or in connection with an instruction execution apparatus, such as a digital signal processor, that can fetch and execute instructions. In the context of this document, a “computer-readable medium” can be any means that can store a program for use by or in connection with an instruction execution apparatus.

The exemplary embodiment of the server 18 depicted by FIG. 2 comprises at least one conventional processing element 25, such as a digital signal processor (DSP) or a central processing unit (CPU), that communicates to and drives the other elements of the server 18 via a local interface 26, which can include at least one bus. When the object manager 17 is implemented in software, the processing element 25 is configured to fetch and execute instructions of the manager 17.

The server 18 also has a network interface 27, such as a modem, for enabling communication with the network 15 (FIG. 1). Furthermore, an input device 28, for example, a keyboard or a mouse, can be used to input data from a user of the server 18, and an output device 29, for example, a printer or monitor, can be used to output data to the user.

Each artist registers with the object manager 17. For each artist, the object manager 17 maintains various information 31, referred to hereafter as “artist information.” For example, the artist information 31 may include an identifier (e.g., name or pseudo-name) that uniquely identifies the artist as well as other information describing the artist's services. As a mere example, the artist information 31 may indicate the artist's rates (e.g., dollars per day) that is to be charged for services rendered by the artist. The artist information 31 also may indicate the artist's skill level and/or artistic ability. For example, the artist information 31 may indicate how many years of experience the artist has as a graphical artists, the number of graphical objects the artist has previously created, and/or other information about the artist's experience. The artist information 31 may also include previous graphical objects created by the artist.

Further, when an artist creates a graphical object, the newly created graphical object can be evaluated by a client or a user of the object manager 17 to provide a score indicative of how well the artist created the object according to a set of criteria. For example, if the artist is asked to render a two-dimensional (2D) drawing of a three-dimensional (3D) graphical object, the 2D drawing can be compared to the 3D object to ascertain how closely the drawing matches the object in order to derive a performance score. In other examples, other combinations of object types can be compared. For example, 2D objects may be compared to 2D objects. The comparisons can be performed manually and/or automatically. The artist's scores for various jobs can be averaged to provide an overall score indicative of the artist's overall performance in handling multiple jobs. Further, information indicative of the scores can be stored by the object manager 17 as part of the artist information 31.

In one exemplary embodiment, the object manager 17 is configured to automatically analyze the object or objects created by an artist in order to evaluate the artist's performance. In performing a comparison of a graphical object created by an artist to another object, referred to hereafter as a “sample,” in order to ascertain a performance score for the artist, various image processing techniques may be performed to determine how well the artist's object matches the sample. For example, the object manager 17 may be configured to use known edge detection algorithms to locate and validate edges of the artist's object relative to the sample. Note that the performance score assigned to the artist can be in a variety of formats. For example, the score may represent a percentage of metrics (e.g., edge comparisons) that are deemed to be matching.

In at least one exemplary embodiment, a client uses one of the client systems 12 to submit a query for finding an artist to electronically draw a particular graphical object. The query may include any of a number of criteria. For example, the query may specify a desired geographic region for the artist (e.g., living in a particular country, city, or state), a desired skill level (e.g., performance score threshold), a desired billing rate, dates of availability, and a desired experience attribute, such as number of years of experience or experience with a specific type of graphical objects. Various other types of artist attributes may be specified by the query. For example, the query may specify a particular type of software for which an artist is to have experience or access.

The query is transmitted through the network 15 to the object manager 17, which searches through the artist information 31 stored at the server 18 to identify artists that satisfy the client's query. The object manager 17 then returns a list of artists that satisfy the search criteria indicated by the query. The list of artists may include various information about the identified artists. For example, the list may indicate the name, skill level, experience level, dates of availability, and/or other information about each artist. The list may also include graphical objects previously created by the artist so that the client can better assess the skill level of the artist by viewing or analyzing such graphical objects. Moreover, the client that submitted the query may review the list and select an artist or a group of artists for creating a particular graphical object. A message indicating which of the artists is selected for a particular job is transmitted from the client's system 12 to the server 18 via the network 15.

In addition, the client's system 12 also transmits various information 33, referred to hereafter as “job information,” indicative of a job requested by the client. For example, the job information 33 may include information indicative of the graphical object to be created by the selected artist. In this regard, the job information 33 may include textual information describing the object to be created and/or graphical information depicting at least portions of the object. As a mere example, the job information 33 may include a 3D model of the object, a hand-drawn picture, or a digital photograph of a real-world object for which the artist is to create a graphical object with a similar appearance.

The object manager 17 assigns an identifier, referred to hereafter as a “job identifier,” to the job information 33. The object manager correlates the job identifier with the job information 33 and transmits the job identifier to the client. Thereafter, when the client initiates a communication session with the object manager 17 or otherwise transmits messages pertaining to a particular job, the client may provide the job identifier to the manager 17, which uses the job identifier to correlate such communication with the appropriate set of job information 33.

The job identifier is also correlated with a client identifier that identifies the client that requested the identified job, and the job identifier is correlated with an artist identifier that identifies the artist assigned by the manager 17 to handle the identified job. Thus, upon receiving a message associated with a particular job identifier, the object manager 17 can identify, based on the job identifier, the job information 33, the artist identifier, and the client identifier correlated with the identified job. Based on such information, the manager 17 can determine the appropriate recipient for the message.

The job information 33 is preferably reviewed by a user of the server 18 to ensure that it includes sufficient information for enabling an artist to create the desired object. In this regard, object manager 17 is configured to display the job information 33 via output device 29. If the displayed job information 33 is acceptable to the user, then the user provides an input via input device 28 verifying the acceptability of such information 33. If the displayed job information 33 is unacceptable, then the user can change the information 33 via input device 28 or send a message to the client providing the information 33.

Once the job information is verified, it is transmitted to the system 21 of the artist selected for creating the object. In this regard, the object manager 17 transmits a message, referred to hereafter as a “job request,” to the system 21 of the selected artist via network 15. The job request includes the job information 33 as well as other information pertinent to the job, such as a deadline for completing the job, an expected amount of time required for completion, and/or other types of information. Such other information may be specified by the requesting client and form part of the job information 33. Any such information may be specified by others, such as a user of the server 18.

The artist may reply to a job request with a message for accepting the job request or rejecting the job request. If the job request is rejected, then the object manager 17 may transmit a message to the client informing him or her of the rejection so that the client can choose another artist to perform the requested job. However, if the artist accepts the job request, then the object manager 17 transmits a message to the client informing him or her of the acceptance. Further, the object manager correlates the job information 33 for the job with identifiers of the artist and the client.

The artist then creates a graphical object 38 according to the received job information 33. The created object 38 is stored by the object manager 17, which provides the client system 12 of the requesting client with viewing access to the object. The requesting client is ultimately provided with the graphical object 38 defined by the job information 33 submitted by such client. Each graphical object 38 is associated with an identifier, referred to hereafter as “object identifier,” that identifies the object 38 relative to the other graphical objects 38.

In one exemplary embodiment, a user and/or owner of the object manager 17 collects fees from the client for the creation of the object according to the job information. A portion of the fees are paid to the artist that created the object. Moreover, the object manager 17 provides a service of matching artists desiring to provide graphical drawing services with clients seeking such services.

As described above, a client may select a particular artist or group of artists to create one or more graphical objects. In one exemplary embodiment, the client identifies a group of artists that are deemed to be acceptable for creating a graphical object, and the object manager 17 selects a subset (e.g., one) of such acceptable artists for the job requested by the client. Note that there are various techniques that may be employed by the object manager 17 to select among the artists identified as being acceptable by the client.

For example, in one embodiment, after the client has selected a group of acceptable artists and transmitted a message to the object manager 17 identifying the acceptable artists, the object manager 17 transmits a job request to a plurality of the acceptable artists. As an example, the object manager 17 may transmit a job request to each of the acceptable artists. In another example, the object manager 17 may transmit a job request to a subset (e.g., a predefined number) of the acceptable artists. The artist that replies first with a message indicating an acceptance of the job request is assigned the requested job by the manager 17. If the manager 17 receives an acceptance message from another artist after an artist has already accepted the job, then the manager 17 replies with a message indicating that the job has been assigned to another artist. Thus, artists wishing to perform the requested job have an incentive to reply with an acceptance as soon as possible.

In another example, the object manager 17 does not necessarily choose the first replying artist but assigns the requested job based on other factors. For example, each artist that replies with an acceptance to the distributed job request may include a bid along with the acceptance. The bid indicates the minimum amount of compensation that the artist is willing to receive in order to perform the requested job. The object manager 17 selects one of the accepting artists based on the bid information. For example, the object manager 17 may assign the job to the artist that accepted the job with the lowest bid. Other techniques for selecting an artist or a group of artist from a list of artists deemed by the client to be acceptable are possible in other embodiments.

In one exemplary embodiment, the object manager 17 affords each artist with an opportunity to blackout certain dates such that the object manager 17 assigns jobs based on the blackout dates specified by the artists. For example, an artist may transmit a message identifying several dates, referred to as “blackout dates,” for which the artist does not want to be assigned any jobs. During such dates the object manager 17 does not assign jobs to such artist. Thus, during such dates, if the object manager 17 receives a client query, the object manager 17 excludes the artist from the search and, therefore, from the list of available artists provided to the client. Accordingly, the object manager 17 and the client are prevented from selecting the artist for a requested job.

Note that the blackout dates could be based on the job completion dates. In this regard, if an artist has identified a particular date as a “blackout date” for job completions, then object manager 17 does not assign the artist to any job with a completion date on the blackout date. Note that the completion date may be specified by the client when requesting a job and form part of the job information 33. Further, the job completion date may be included in the client query and used by the object manager 17 as a search parameter in searching for acceptable artists in response to the client query. In this regard, the object manager 17 excludes from the search any artist who specified a blackout date on the date of completion indicated by the client query.

In addition, in one embodiment, the artist information 31 includes a calendar for each artist indicating the artist's blackout dates. The artist may access and update his or her calendar from time-to-time. Such calendar may be used by the object manager 17 in searching for suitable artists as described above. Information from the calendar may also be provided to the client, such as when a list of potential artists is provided to the client, so that the client can use such information as a factor is selecting an artist for a particular job. In this regard, after performing a search for suitable artists, the object manager 17 may transmit a list of artists who satisfy the search query. The list is received by the client system 12 that submitted the query, and the system 12 displays the list to the client. The list may include information about each displayed artist, such as performance score, information about the artist's skill level and/or experience, and/or information about the artist's availability as indicated by the artist information 31.

In one exemplary embodiment, an artist's calendar is automatically updated by the object manager 17 based on a job accepted by the artist. For example, assume that the artist accepts a job that requires the artist to work during a specific time period. Upon acceptance of such job by the artist, the object manager 17 is configured to automatically update the artist's calendar to indicate that the artist is unavailable for other jobs during such time period.

To encourage an artist to voluntarily update his or her calendar, the object manager 17 is configured to adjust the artist's performance score based on whether and/or to what extent the artist updates his or her calendar. Further, the artist's performance score may be based on whether and/to what extent the artist uses other features of the system 10.

As a mere example, the server 18 may host a social network that enables users, such as artists and clients, to interact and share information. For example, some users may post tutorials regarding graphical drawing techniques or other topics that can be read by other users. Some users may voluntarily translate tutorials or other community information from one language to another. Some users may directly tutor other users in an effort to improve their graphical drawing ability and skills. When any such activity is performed, the object manager 17 may receive notice of such activity from the user or otherwise and adjust the user's performance score. Thus, a user may be motivated to participate in various activities in order to enhance his performance score.

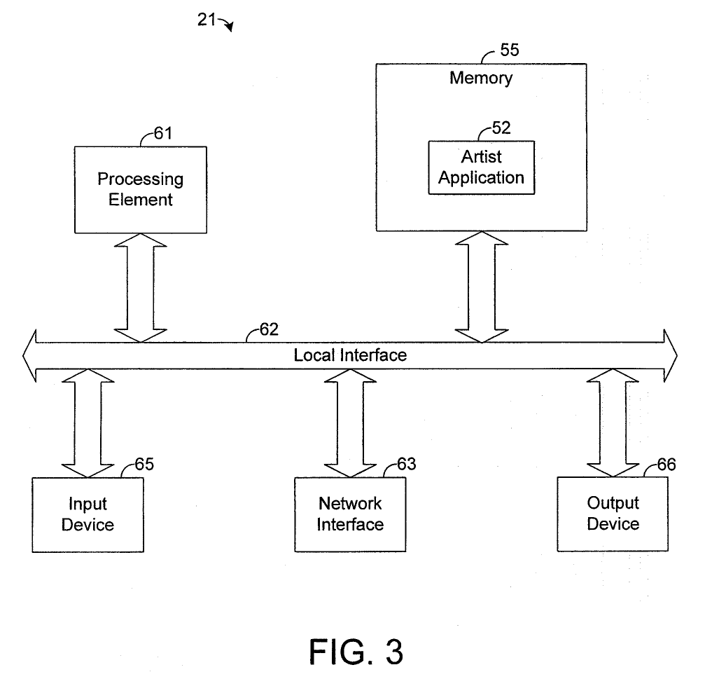

FIG. 3 depicts an exemplary embodiment of an artist system 21. As shown by FIG. 3, the system 21 comprises an artist application 52, which is implemented in software and downloaded from the server 18. In other embodiments, the artist application 52 can be received from other sources, and the application 52 can be implemented in any combination of software, firmware, and hardware.

Note that the artist application 52, when implemented in software, can be stored and transported on any computer-readable medium. In the embodiment shown by FIG. 3, the artist application 52 is stored in memory 55 of the artist system 21.

The exemplary embodiment of the system 21 depicted by FIG. 3 comprises at least one conventional processing element 61, such as a digital signal processor (DSP) or a central processing unit (CPU), that communicates to and drives the other elements of the system 21 via a local interface 62, which can include at least one bus. When the artist application 52 is implemented in software, the processing element 61 is configured to fetch and execute instructions of the application 52.

The system 21 also has a network interface 63, such as a modem, for enabling communication with the network 15 (FIG. 1). Furthermore, an input device 65, for example, a keyboard or a mouse, can be used to input data from a user of the system 21, and an output device 66, for example, a printer or monitor, can be used to output data to the user.

In one exemplary embodiment, when an artist registers with the object manager 17, the artist application 52 is downloaded from the server 18 to the artist's system 21. The artist application 52 provides a tool that allows users to create and modify graphical objects. Thus, the artist may use the artist application 52 to create (e.g., draw) the graphical object 38 specified by the job information 33 in a job request. When running, the artist application 52 is configured to periodically (e.g., every 15 minutes) transmit a copy of the graphical object 38 being modified by the artist application 52. Each object 38 managed by the object manager 17 is preferably associated with the job identifier that identifies the set of job information 33 used by the artist to create the object. When the artist application 52 transmits a graphical object 38 to the server 18, the artist application includes the object's associated job identifier. Using this identifier, the object manager 17 locates the corresponding graphical object 38 in memory 24 that is to be replaced or otherwise updated by the transmitted object 38. The object manager 17 then replaces or otherwise updates the located object 38 using the object 38 received from the artist application 52.

Accordingly, data defining each graphical object 38 being managed by the manager 17 is stored at the server 18 or is otherwise accessible to the object manager 17. In one exemplary embodiment, the object manager 17 prevents the objects 38 from being accessed by unauthorized users. In this regard, the object manager 17, for each object 38, maintains a list of users authorized to access the object, such as the client requesting the object 38 and the artist assigned to work on the object. Any such authorized user may access the object from the server 18 using procedures referred to as “check-in” and “check-out.” For example, the artist assigned to work on an object 38 may submit a request via the artist application 52 to check-out an object 38 that has been previously created and stored by the object manager 17 thereby beginning a modification session for modifying the object. When an object is checked-out, it is downloaded to an artist system 21 (or other user system) and is subject to being modified by the artist (or other user). The artist may modify the checked-out object (e.g., continue creation of the object) during the modification session and then end the modification session by submitting a request for checking-in the modified object. The request includes data defining the modified object, and such data is used to replace or otherwise update the previous version of the object 38 stored by the object manager 17. Thus, when an object 38 is checked-in, the version stored at the server 18 by the object manager 17 is the most recent version of the object 38.

As described above, a client may select a plurality of artists to work on a graphical object. If multiple artists are assigned to the same graphical object 38, then any such artist may check-out and work on the object 38. The check-in and check-out procedures described above help to maintain data consistency by preventing multiple artists from changing the graphical object at the same time.

As described above, when an object is checked-out, the artist application 52 of the artist system 21 periodically transmits, via network 15, data defining the object 38 being modified to the object manager 17, along with the job identifier for the object 38. When the object manager 17 receives this object, the object manager 17 uses the job identifier to access the previous version, if any, of the object 38 stored at the server 18. If there is no previous version, then the object manager 17 assumes that the object has been newly created and stores the object 38 without comparing the object 38 to any previous version. The object manager 17 also stores a time stamp indicating when the object being stored was received by the object manager 17.

However, if there is a previous version of the received object 38, the object manager 17 compares the received object 38 to the previous version to determine if there are any differences and stores the received object 38 along with a time stamp. Further, based on the comparison results, the object manager 17 tracks the total time that the artist spends creating the object. In this regard, if the previous version and the received object match, then the object manager 17 is aware that no work was performed on the object since transmission of the previous version to the object manager 17. However, if the previous version and the received object do not exactly match, then the object manager 17 is aware that at least some work was performed in the interim. Thus, the object manager 17 can identify time periods when the object 38 is checked-out by the artist application 52 but no work is being performed on the object. Accordingly, the object manager 17 can track with a relatively high degree of accuracy when work is actually being performed on a graphical object 38 by an artist. Such information may be useful for a variety of reasons. For example, if a deadline is missed by the artist, such information may reveal that the artist did not spend a sufficient amount of time trying to complete the object. Thus, the reason for missing the deadline can be more accurately determined.

In one exemplary embodiment, the object manager 17 makes an entry in memory 24 each time it receives an update from an artist system 21. Each entry includes the time that the update was received and indicates whether any work was performed since the last update received for such object. The object manager 17 also makes an entry each time an object 38 is checked in or out. Such entries include the time of check in or out. Upon request, the data from such entries is displayed to a user, for example, by output device 29. By analyzing such data, time periods in which a graphical object was checked-out and being worked on can be identified thereby enabling a user or the object manager 17 to automatically calculate the amount of time that an artist spent working on the object 38.

Note that the amount of time spent by the artist may be used as a factor in determining the artist's skill level or artistic ability. Indeed, the artist information 31 used to select artists may be updated based on the amount of time spent by the artist in completing the object. In this regard, an artist who spends less time generating a comparable object may be deemed to be more skillful than an artist who spends more time. Thus, in one embodiment, the object manager 17 is configured to enhance an artist's performance score in response to a determination that the artist completed a job in a relatively short amount of time. In addition, the object manager 17 is configured to reduce an artist's performance score in response to a determination that the artist completed a job in a relatively long amount of time.

Note that an artist has an incentive to perform work and/or otherwise use the system 10 in a manner that tends to enhance his or her performance score. In this regard, as described above, a client may submit job queries or select the artist for a job based on the artist's performance score. Thus, a better performance score increases the chance of receiving job invitations and/or receiving invitations for better jobs, such as jobs that pay the artist at a higher rate. Further, in one exemplary embodiment, the object manager 17 is configured to use an artist's performance score to adjust the pricing of the artist's services. For example, an artist's pay rate may be adjusted downward if his or her performance score is lowered below a threshold due to negative feedback from clients or performance that is deemed unsatisfactory. In another example, the artist's pay rate may be adjusted upward if his or her performance score is increased above a threshold due to positive feedback from clients or performance that is deemed satisfactory.

In at least one exemplary embodiment, the artist application 52 prevents the artist from saving illicit copies of the object on the artist system 21, although versions of the object may be temporarily stored in the system 21 by the artist application 52 while it is running. For example, while the artist application 52 has an object 38 checked-out, the object 38 is stored to the artist system 21 and is accessible to the artist application 52 so that the object can be displayed and modified by the artist via application 52. However, the artist application 52 does not allow the artist to otherwise save or make copies of the object 38. Further, when an artist ends a modification session and checks-in the object 38 being modified during the session, the artist application 52 deletes, from the artist system 21, all data pertaining to the object 38. Further, the artist application 52 does not allow the artist to close the application 52 until the object or objects being modified are checked-in to the object manager 17. Thus, once the artist application 52 is closed, no copies of any of the objects should exist on the artist's system 21. Such techniques may frustrate attempts by the artist to use the object outside of the artist application 52. Therefore, the artist may be prevented from using the object for any purpose other than satisfying the job request thereby helping to protect the object from unauthorized use.

In addition, at any time, the client who requested the job can monitor the progress of the job by accessing the graphical object 38 stored at the server 18. Thus, the client may analyze the graphical object 38 being created and may discover problems with the object 38 early in the development process before the object is actually completed. The client may communicate feedback about the object to the object manager 17, which then provides such feedback to the selected artist who is creating the graphical object. Thus, misunderstandings or other problems about the graphical object or its design can be identified and resolved early in the development process.

In one embodiment, the client via a system 12 submits a request, referred to as a “view request,” to the object manager 17 in order to view a particular one of the objects 38 being managed. The view request includes the job identifier for the object 38 to be viewed. Based on such identifier, the object manager 17 locates the appropriate object 38 and transmits data defining the object to the requesting system 12, which then displays the object 38. Alternatively, the client can access an object 38 by checking-out the object 38. Note that a view request differs from a check-out procedure in that the requesting user for a view request is not allowed to modify the object 38 at the server 18 during viewing. Thus, another user, for example, the artist creating the object 38, is allowed to check-out and modify the object 38 while the client (or other user) is viewing the object 38. In essence, a view request allows multiple users to access the same object 38 without creating additional data consistency issues or risks.

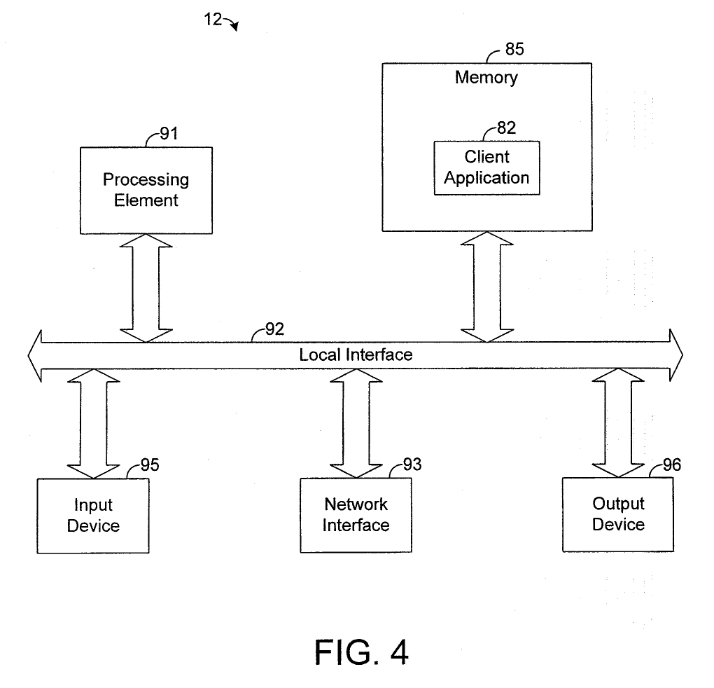

FIG. 4 depicts an exemplary embodiment of a client system 12. As shown by FIG. 4, the system 12 comprises a client application 82, which is implemented in software and downloaded from the server 18. In other embodiments, the client application 82 can be received from other sources, and the application 82 can be implemented in any combination of software, firmware, and hardware.

Note that the client application 82, when implemented in software, can be stored and transported on any computer-readable medium. In the embodiment shown by FIG. 4, the client application 82 is stored in memory 85 of the client system 12.

The exemplary embodiment of the system 12 depicted by FIG. 4 comprises at least one conventional processing element 91, such as a digital signal processor (DSP) or a central processing unit (CPU), that communicates to and drives the other elements of the system 12 via a local interface 92, which can include at least one bus. When the client application 82 is implemented in software, the processing element 91 is configured to fetch and execute instructions of the application 82.

The system 12 also has a network interface 93, such as a modem, for enabling communication with the network 15 (FIG. 1). Furthermore, an input device 95, for example, a keyboard or a mouse, can be used to input data from a user of the system 12, and an output device 96, for example, a printer or monitor, can be used to output data to the user.

In at least one exemplary embodiment, the client, like the artist, registers with the object manager 17, and the client application 82 is downloaded from the server 18 to the client's system 12. The client application 82, like the artist application 52, provides a tool that allows the system 12 to display and modify graphical objects, such as graphical objects managed by the manager 17. During the development of a graphical object 38, a client may use the client application 82 to access and display the graphical object 38 being created for the client, and the client may provide feedback about the graphical object 38, as described above. If desired, the client may use the client application 82 to modify the graphical object 38. Indeed, the client, using the client application 82, may check-out an object 38, modify the object 38, and check-in the modified object 38 just like the artist using the artist application 52. If the client makes any modifications to the object, the modifications can be saved to the server 18 by checking-in the modified version of the object 38. When an object 38 is checked-out by either the artist or client, other parties may be prevented from checking-out the object in order to prevent conflicts caused by multiple parties modifying the object 38 at the same time.

In one exemplary embodiment, the client application 82 prevents the client from saving or making copies of the graphical object until at least the object manager 17 receives verification that the client has sufficiently paid for the development of the graphical object 38. Such a feature can help ensure that the client pays for the service of creating the object 38. As an example, either during or after the development of a graphical object 38, the client may be requested to make a threshold payment before being allowed to save or make copies of the graphical object 38. Once the object manager 17 receives verification that such a payment has been made by the client, the object manager 17 transmits a notification to the client application 82 that saving or making copies for the graphical object is authorized. Such notification may include the job identifier. In response to such notification, the client application 82 is configured to allow the client to save, make copies of, or otherwise access the identified object. Note that the object manager 17 may verify payment via any of a number of ways. For example, the object manager 17 may receive an electronic payment from the client's system 12. In another example, payment is received by the operator or owner of the server 18, and such operator or other user inputs data to the server 18 indicating that payment has been received. Various other techniques for verifying payment are also possible.

In addition, information may be communicated to the artist and/or client via any of various communication systems. For example, email or short message service (sms) may be employed to communicate message to or from the artist or client. As an example, after reviewing the object being created, the client may transmit an email, sms, or other type of message to the artist. Also, the artist may communicate questions or other types of messages to the client via email, sms, or some other form of communication. The object manager 17 may serve as an intermediary for such messages. For example, an email or sms message could be sent by the artist to the object manager 17, which then forwards the message to the client. In such an embodiment, it is unnecessary for either the artist or the client to be aware of the address of the other.

After completion of the graphical object, the object manager 17 requests the client to provide feedback about his or her impressions of the artist who created the object. For example, the client may be asked to rate the artist's work product quality and/or other parameters, including but not limited to accuracy, timeliness, skill level, cost effectiveness, and creativity. The object manager 17 may update the artist information 31 and, in particular, the artist's performance scores based on the feedback from the client.

In one exemplary embodiment, when an object 38 is checked-out by an artist application 52, client application 82 or otherwise, the object manager 17 generates a unique identifier, referred to hereafter as watermark identifier, for the object 38 and attaches the watermark identifier as metadata to the graphical object 38 being checked-out. As an example, the first time any object 38 is checked-out, the object manager 17 may assign a value of “1” as the watermark identifier. Each successive time that any object 38 is checked out, the object manager 17 may increment the previous watermark identifier to generate a new watermark identifier for the transaction. Thus, the second time any object 38 is checked-out, the watermark identifier may be “2,” and the third time any object 38 is checked-out, the watermark identifier may be “3.” Other algorithms may be used for assigning watermark identifiers in other embodiments. As a mere example, a watermark identifier may be a random number of a combination of an object identifier and a random number.

Each time an object 38 is checked-out, the object manager 17 adds an entry to data 45 (FIG. 2), referred to hereafter as “watermark data,” which may be implemented as a table or other type of data structure. The object manager 17 stores in the new entry the object identifier of the object 38 being checked-out and the watermark identifier generated by the object manager 17 for the current check-out procedure. The object manager 17 also stores the artist identifier, client identifier, or other identifier associated with the user who is requesting the check-out procedure. Thus, the watermark data 45 is essentially a record indicative of users who accessed graphical objects 38 and which versions of the graphical objects 38 have been accessed by such users.

In one exemplary embodiment, upon receiving an object 38, the artist application 52 or client application 82 is configured to contact the object manager 17 before displaying the object 38. In this regard, the application 52 or 82 provides the artist identifier, client identifier, or other identifier associated with the user of the system 21 or 12 (collectively referred to as “user identifier”), and the application 52 or 82 provides the watermark identifier for the object. Upon receiving such identifiers, the object manager 17 is configured to locate the entry of the watermark data 45 having the received object identifier and watermark identifier. If the user identifier (e.g., artist identifier or client identifier) of the entry matches the received user identifier, then the object managers 17 transmits an authentication message to the application 52 or 82. In response, the application 52 or 82 displays the object 38 or otherwise allows the user to access the object 38. If the compared identifiers do not match, then the object manager 17 transmits to the application 52 or 82 a message indicating that the user is not authenticated. In response, the application 52 or 82 does not display the object 38 to the user or otherwise allow the user to access the object 38. Thus, the system 10 helps to ensure that only users that have checked-out an object 38 via the object manager 17 are able access the data of the checked-out object 38.

In another embodiment, the object manager 17 may authenticate the user based on the job information 33. In this regard, the object manager 17 may consult the set of job information 33 correlated with the object 38 to determine which users are authorized to access the object 38, and the object manager 17 may authenticate any user authorized to access the object 38. Thus, the user who checked-out an object 38 may share the checked-out object 38 with another user authorized by the job information 33 to access the object 38, and such other user may use his artist application 52 or client application 82 to access (e.g., display) the checked-out object 38.

Furthermore, if an illicit copy of the object 38 is found or if the checked-out object 38 is otherwise misused in any way, then the watermark data 45 may be used to help identify the person who misused the checked-out object. In this regard, upon discovering a misused object 38, a user may analyze the metadata to discover the watermark identifier of the object 38. The user may then provide the watermark identifier to the object manager 17. For example, the user may submit a request, referred to hereafter as a “trace request,” which includes the watermark identifier, to the object manager 17 via the network 15 or otherwise (e.g., via a user input submitted directly to the server 18). Upon receiving the trace request, the object manager 17 is configured to find, in the watermark data 45, the watermark identifier of the trace request and to return the user identifier correlated with (e.g., stored in the same entry) the watermark identifier in the data 45. Such user identifier identifies the user who originally checked-out the misused object 38. In this regard, as described above, the object manager 17 is configured to store the user identifier of the user requesting a check-out along with the object identifier of the object 38 being checked-out and the watermark identifier generated for the check-out procedure. The person identified by the returned user identifier may be responsible for the misuse or may be able to provide information to help trace the source of the misuse. Accordingly, using the watermark identifier found in the misused object 38, the identity of a person who misused a checked-out object 38 may be discovered, and the use of the watermark identifiers may serve as deterrent to those considering an illicit use of a checked-out object 38.

Note that the artist application 52 can be custom-designed to perform the functions described herein. However, many drawing programs for creating and modifying graphical objects currently exist. It is possible to implement the artist application 52 via such conventional programs. In one embodiment, a plug-in is added to a conventional drawing program in order to implement the artist application 52 described above. The plug-in handles communication with the sever 18 and various other functions that may be desired.

Note that many drawing programs allow users to save copies of the graphical objects being manipulated. In at least one exemplary embodiment, as described above, the artist is prevented from saving or making copies of object 38 outside of the application 52. A conventional drawing program, which typically allows user-saves, can be modified to prevent such saves. In one embodiment, a drawing program that allows saves is used without modifying the program in order to disable the user-save feature. However, the plug-in that is added to the drawing program to implement the artist application 52 is configured to prevent the drawing program from saving a usable version of the graphical objects manipulated by the application 52 in response to a save command from the artist. In this regard, the plug-in is configured to discover when the user has submitted a save command via the drawing program. Upon such occurrence, the plug-in is configured to delete, scramble, or otherwise invalidate the graphical data defining the object 38 in the artist system 21. In one exemplary embodiment, the plug-in scrambles such data by changing the color and/or position values of each pixel according to a predefined algorithm so that the appearance of the graphical object is significantly changed.

In one embodiment, the scrambling algorithm is based on a value or key known to the plug-in and/or object manager 17 such that the value or key can be used to later descramble the data to recover the graphical object as it existed just prior to the scrambling operation. Thus, in essence, the data defining the graphical object is effectively encrypted with the possibility of being later decrypted after execution of the detected save command. As a result of the scrambling operation, any data saved in response to the save command is unusable thereby preventing the artist (or other user) from making illicit copies of the graphical object, which is likely owned by the client requesting (and possibly paying for) creation of such object. Note that, in addition to scrambling the graphical data at the artist system 21 in response to a save command, the plug-in may be configured to disconnect from the server 18 so that communication between the server 18 and the artist system 21 does not occur during the requested save operation.

In one exemplary embodiment, the object manager 17 is configured to archive various data 31, 33, 38 and messages. Thus, if a problem is encountered, such as a dispute between an artist and client, the archived data can be reviewed in an effort to resolve the dispute. For example, if a client finds a finished product to be unacceptable, the data and messages can be reviewed to see if the artist actually met the specified requirements or whether the artist failed to comply with the instructions of the client.

In one exemplary embodiment, the object manager 17 even archives the drawing commands that are generated by the artist application 52 in order to manipulate the graphical object 38 being created. Such commands may be transmitted in batches periodically or otherwise. In one embodiment, the commands are sent in real-time as an artist is working on an object 38. In this regard, when an artist submits a command for modifying the graphical object 38 accessed via the artist application 52, the artist application 52, in response to such command, modifies the object 38 being displayed at the system 21. The application 52 also transmits the command to the object manager 17, which stores the command in memory 24. If desired, the object manager 17 manipulates the object 38 at the server 18 in response to the command so that the object 38 at the server 18 is updated in real-time.

If the object 38 at the server 18 is updated in real-time, then the client may submit a view request for viewing the object 38 at the server 18 in real-time. In response to such a request, the object manager 17 streams the graphical data defining the object 38 to the client system 12, which displays such data via output device 96. Thus, as the artist is manipulating the graphical object 38, the client is viewing the changes in real-time. In essence, the client is provided with a virtual viewing room in which the graphical object 38 is displayed. Thus, the client is able to see the same view of the object 38 as the artist as if the client were looking over the shoulder of the artist while he or she is working. Based on the client's observations, the client may provide feedback for assisting the artist in completing the job in a satisfactory manner. Such feedback may be communicated through the object manager 17 to the artist, as further described herein.

Storing the individual drawing commands allows the artist's work to be re-created and observed by the client at a later time. For example, as described above, a client may access a graphical object via a check-out procedure or a view request. When accessing an object, the client application 82 may request retrieval of the archived drawing commands and an archived version of the object 38 as it existed prior to execution of the retrieved commands. The client application 82 may then execute the drawing commands in the same order that the artist previously submitted such commands to display a temporal progression of the artist's object manipulations. In this regard, the client sees the object 38 changing over time based on a historical record of the drawing commands submitted by the artist. Thus, although the artist has previously performed the work being viewed, it is as if the client is seeing such work at the time of performance. In this regard, the client is essentially viewing a recording of such work. Such information may be useful for a variety of purposes. For example, the information may be helpful in evaluating the artist's performance. Also, such information may provide insight into the techniques being used by the artist to create the object. Based on such insight, the client may be able to provide comments to the artist for helping him or her to complete the requested job or future jobs more effectively or efficiently. Various other uses of the information are possible in other embodiments. Further, other users, such as users of the server 18 or even the artist, may similarly view a progression of the object manipulations based on archived commands.

As described above, the object manager 17 is configured to archive various items, such as messages, commands, graphical objects, and other data objects, for various reasons, such as helping to resolve a dispute between a client and an artist or helping to discover the source of such a dispute. In one exemplary embodiment, each archived item is associated with a timestamp. For example, an archived data message or command may be associated with a timestamp indicative of when it was generated, transmitted, or received by a component of the system 10, such as server 18. Archived data defining a graphical object may be associated with a timestamp of when the graphical object was archived.

The object manager 17 is configured to utilize the timestamps of the archived items to present the items in a chronological order. For example, the object manager 17 may display the items in an order from oldest to newest. In one exemplary embodiment, a user submits a request for viewing the archived items, and the object manager 17 displays or otherwise provides the items in chronological order. In addition, the archived items are categorized so that the object manager 17 can display or otherwise provide a selected group of the items in chronological order or some other order. As an example, a user may submit a request for viewing data messages in a chronological order. In response, the object manager 17 is configured to retrieve the archived messages and display such messages in chronological order without retrieving and displaying other archived items. In other embodiments, other categories or combination of categories may be displayed in response to a request identifying such categories.

It may be desirable to prevent a client from learning the identity of the artist that is creating a graphical object for the client. In this regard, if the client learns of the artist's identity, then the client, for future jobs, may deal directly with the artist and not utilize the services provided by the object manager 17. Various techniques to keep the identity of the client from the artist and the identity of the artist from the client are possible.

For example, in one exemplary embodiment, the object manager 17 does not provide the address of the artist to the client or the address of the client to the artist. To communicate a message to the client, the artist sends the message to the object manager 17, which then forwards the message to the client. To communicate a message to the artist, the client sends the message to the object manager 17, which then forwards the message to the artist. Thus, any message to be communicated from one party to the other passes through the object manager 17, and neither party is aware of the address of the other. In this regard, only the object manager 17 is aware of the address of the client and the artist.

There are various techniques that can be used to achieve the foregoing. For example, the client and artist may provide a job identifier to enable the manager 17 to forward a message to the appropriate party. For example, when sending a message pertaining to a particular job, the client may provide the job identifier for the job. Such job identifier may be included in the message or provided during the communication session in which the message is transmitted. Based on the job identifier, the manager 17 may locate the artist identifier correlated with such job identifier and forward the message to the address of the identified artist. Similarly, the artist may provide a job identifier to enable the manager 17 to forward messages to the appropriate client. Rather than providing a job identifier, artist and client identifiers, such as the pseudo-names described below, may be provided to the manager 17. Various other techniques for enabling the manager 17 to correlate a message with the appropriate recipient are possible.

In one exemplary embodiment, the object manager 17 creates a virtual chat room for the client and artist once a job has been requested and assigned to an artist. For example, the chat room may be automatically created in response to an acceptance reply to a job request. The chat room may be correlated with the job identifier. In this regard, to transmit a message for viewing by the artist in the virtual chat room, the client may provide the job identifier along with such message or session in which the message is transmitted to the server 18. Based on the job identifier, the manager 17 correlates the message with the appropriate chat room so that it can be viewed by the artist assigned to the job. Similarly, the artist may provide the job identifier for messages to be viewed in the chat room.

Further, in one embodiment, the client and the artist register with the object manager 17. During such registration process, the object manager 17 receives and stores various personal information, such as name, address, telephone number, and/or other contact information about the artist and client. Before forwarding any message or other information to either a client or artist, the object manager 17 first scans such message or other information for any personal information pertaining to the sending party. If the object manager 17 locates such personal information, then the manager 17 takes further action to prevent such information from being received by the other party. For example, the manager 17 may delete or otherwise obfuscate the detected personal information before sending the information to the receiving party. In this regard, the manager 17 effectively filters the personal information from the communication. In another example, the object manager 17 alerts a user of the server 18 so that the user can examine the information before it is sent to the receiving party. Such user has the option of instructing the manager 17 to prevent the information from being transmitted or to modify the information before it is sent in order to keep one party from receiving the personal information of another party.

In one embodiment, the clients and artists are assigned pseudo-names, which are used in lieu of their real names. For example, rather than providing a client with the real name of an artist, the object manager 17 is configured to provide the artist's pseudo-name that is assigned to the artist by the manager 17. Thus, the client may use the pseudo-name to identify the artist (e.g., to select the artist for a particular job) without learning of the artist's real name. Similarly, the artist may be provided with a pseudo-name of a client for which he or she is creating a graphical object.

In one embodiment, the pseudo-name assigned to a party, such as an artist, is not freely selected by the artist but is instead provided by the manager 17. For example, the manager 17 may provide a party with a predefined list of names or other identifiers (e.g., numbers) from which the party may select one or more names or other identifiers to serve as the party's pseudo-name. If desired, multiple selected names or other identifiers may be concatenated together to form a single pseudo-name. Although the party can select a name or identifier from a predefined list, the party is unable to generate any portion of the pseudo-name helping to prevent the user from conveying personal information about the party via the pseudo-name.

As described above, the system 10 implements several security features that prevent artists from making illicit copies of the graphical object being created. One methodology for achieving this feature involves the client application 52 which is authorized and is able to access the graphical object 38 stored at the server 18. The application 52 retrieves a copy of the graphical object 38 and maintains control over such data. In this regard, the application 52 does not include a save feature that allows the artist to save the object 38 outside of the application 52. Thus, the object 38 is stored only in memory allocated to the application 52 and under the control of the application 52. As described above, the application 52 deletes or otherwise obfuscates any versions of the object local to the system 21 before closing. Thus, a version of the object 38 only exists on the system 21 as long as the application 52 is running and is protecting such version.

In one exemplary embodiment, the application 52 and object manager 17 communicate via an encryption algorithm known to the application 52 and manager 17. Such algorithm or keys used for encryption are preferably unknown to other applications at the artist system 21. Thus, the artist is effectively prevented from trying to use an application other than the artist application 52 to access the objects 38 stored at the server 17.

In addition, in one exemplary embodiment, the object manager 17 is configured to use password authentication before transmitting a graphical object to an artist system 21. In this regard, when requesting retrieval of an object 38, the artist application 52 provides a valid password known only to the application 52 and manager 17. In this regard, the artist is not privy to the password and, therefore, cannot attempt to use the password with another application in order to access an object 38. In one embodiment, the password is embedded in the code of the application 52. In another embodiment, the application 52 is configured to determine the password according to some predefined algorithm. For example, the application 52 may calculate a password based on the MAC address of the system 21 or some other parameter that is known by the application 52 and the manager 17. The manager 17 may similarly calculate the password via the same algorithm to enable the password authentication. Other techniques for determining the password used by the manager 17 to authenticate the application 52 are possible in other examples.

In addition, similar security measures may be used for the client system 12 in order to prevent the client from gaining access to a graphical object 38 before paying for such object 38. In this regard, encryption and password authentication, as described above between the manager 17 and the artist system 21, may be used between the manager 17 and the client system 12 in order to prevent the client from gaining illicit access to the graphical object 38 being created. In this regard, password authentication using passwords unknown to the client may be used by the manager 17 and client application 82 in order to authenticate the application 82 so that the same password cannot be used by the client with another application to access the objects 38.

Further, as described above, a client may use the client application 82 to view an object 38 as it is being created. However, like the artist application 52, the client application 82 does not include a save feature that allows the client to save a version of the object 38 outside of the application 82. Thus, the object 38 is stored only in memory allocated to the application 82 and under the control of the application 82. Further, the application 52 deletes or otherwise obfuscates any versions of the object local to the system 12 before closing. Thus, a version of the object 38 only exists on the system 12 as long as the application 82 is running and is protecting such version. Although the client can view an object 38 via the client application 85, the client is unable to freely use the data defining the object 38 for other purposes and with other applications.

However, once the client has paid for the services rendered by the artist, then the object manager 17 provides the client with an unprotected version of the object 38, and the client may use such unprotected version as he or she sees fit. In this regard, the fees to be charged for completing a job may be determined via any number of ways. For example, the total cost for completing a requested job may be agreed up-front, or the client may agree to pay an hourly or a daily rate based on the amount of time the artist spends working on the object 38. When the artist completes a job, the artist transmits a message to the object manager 17 indicating completion of the job. The object manager 17 informs the client of the job completion, and the client is afforded the opportunity to review the completed object 38. In any event, once the client effectuates suitable payment, as verified by the object manager 17, the manager 17 releases the protected object 38 from various security rules effectuated by the client application 82 and/or the object manager 17. Accordingly, the client can access the object 38 via applications other than the client application 82 or save the object 38 to any memory or system.

Note that the client application 82 may provide various tools for assisting the client in evaluating the graphical object 38. For example, as described above, edge detection may be used to compare the graphical object 38 to a sample. Further, the client application 82 may render the graphical object 38 and a sample side-by-side to facilitate a visual comparison of the object 38 and sample. The client application 82 may be configured to overlay the object 38 on a sample or vice versa to assist with a visual comparison. Various other techniques may be used to assist with the comparison.

If the completed object is unacceptable to the client, the client transmits, to the object manager 17, a message indicating rejection of the completed object. Such rejection is communicated to the artist who may then attempt to cure any problems identified by the client. This process may be repeated until the client accepts the completed object.

Once the completed object is deemed acceptable to the client, the client transmits, to the object manager 17, a message indicating acceptance of the completed object. The object manager 17 responds by indicating the amount of compensation that is due for the artist's services. Note that, as described above, the manager 17 may automatically track the amount of time that the selected artists expends creating the requested object. For example, the manager 17 may track the amount of time that the object 38 is checked-out. If desired, the time could be adjusted to account for time periods that the manager 17 determines the object 38 is checked-out but no work is being performed. The total compensation due from the client may be based on the time tracked by the manager 17.

For example, the client may specify the payment amount or method for calculating the payment amount when requesting a job. Such information may form part of the job request so that the artist can consider such information as a factor in whether to accept the requested job. If the payment is based on the number of hours or days that is expended by the artist, then the manager 17 is configured to automatically track the hours or days worked on the object by the artist and use this information to calculate the payment that is due.

Note that the payment may be made via any known technique. In one embodiment, electronic payment is effectuated through the object manager 17 via credit card or some other method of payment. Once the object manager 17 verifies that payment has been effectuated, the object manager 17 electronically sends a portion of the payment to the artist. Note that the payment can be split among the operator of server 18 and the artist as may be agreed upon by such parties.

After verifying payment, the object manager 17 also provides the client with an unprotected version of the graphical object 38. For example, the object manager 17 may transmit the object 38 via email or otherwise such that the object 38 can be accessed by various applications other than the client application 82. Alternatively, the object manager 17 may transmit the object 38 to the client application 82 along with instructions to the application 82 to allow client access to the object 38. Based on such instructions, the application 82 is configured to allow the client to save the object 38 outside of the application 82 or otherwise manipulate the object 38 as may be desired by the client. By limiting the client's access to the object 38 until payment is verified, the system 10 provides the client with additional incentive to effectuate the agreed upon payment.

It should be noted that payments can be made as various milestones are achieved. For example, in one embodiment, the client may agree to make 50% of the total amount when 50% of the work is complete. When the artist believes that the version of the object 38 represents 50% of the requested work, the artist may so indicate to the manager 17, and the client may be notified and allowed to inspect the version, as described above for the completed object. If the client confirms that the version is acceptable and makes the required payment (i.e., 50% of the total payment in this example), then the object manager 17 provides the client with unprotected access to such version. In other examples, rather than agreeing on set percentages, the client may agree to make various payments as certain portions of an overall object is being created. In any event, rather than making a single payment after completion of a job, incremental payments may be effectuated as work on the object 38 progresses.

As described above, the system 10 allows a client to submit a query to find artists that meet a defined set of criteria established by the client. For example, as described above, the object manager 17 may be configured to transmit, to a client, a list of artists satisfying a search query issued by the client. In one exemplary embodiment, the list is presented on one or more web pages transmitted to the system 12 used by the client. The transmitted web page may include other information about the artists listed on the web page, such as information about pricing, location, skill level, performance scores, work samples (e.g., graphical objects previously created by the artist), etc.

In one exemplary embodiment, each artist name or pseudo-name listed on the web page is associated with a hyperlink that the client can select to see more information about the artist. For example, in response to selection of a hyperlink associated with a particular artist, the object manager 17 may be configured to reply with data defining images of graphical objects previously created by the artist. Further, the web page has a hyperlink or other graphical item that can be selected to indicate whether a particular artist has been selected by the client for the current job.

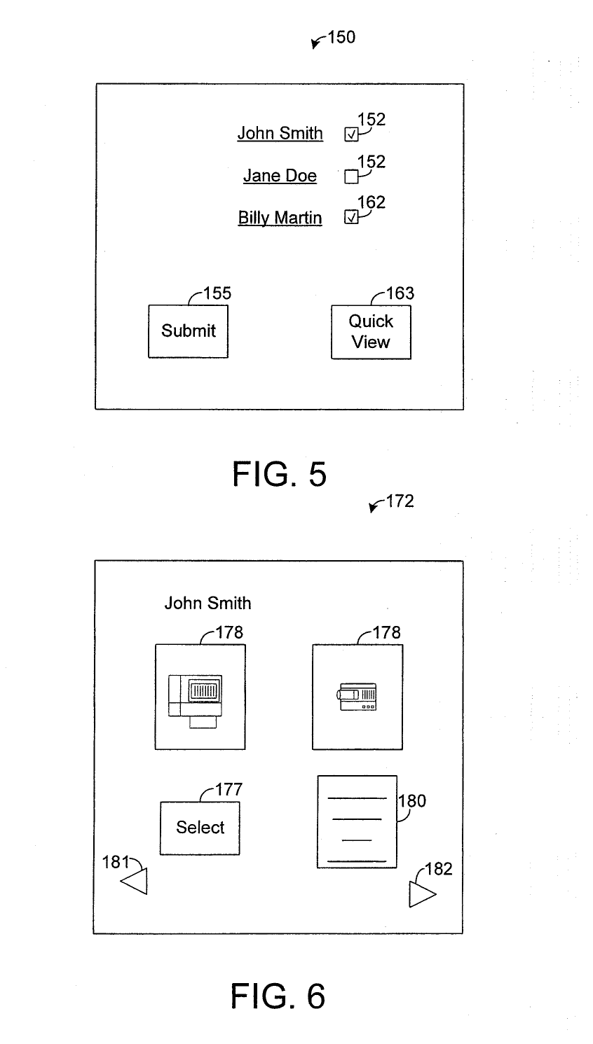

As a mere example, refer to FIG. 5, which depicts an exemplary web page 150 that may be displayed in response to a client query. For simplicity, the web page 150 is shown as displaying three artists names that satisfied the query. In other embodiments, other numbers of names may be displayed. Each artist name is also a hyperlink that, when selected, requests additional information about the artist. The web page 150 also has a graphical box 152 associated with each name. When selected, each box 152 displays a check mark. Thus, the web page 150 indicates that the graphical boxes 152 associated with artists identified by the names “John Smith” and “Billy Martin” have been selected. Thus, when the user selects a “submit” button 155, the client system 12 displaying the page 150 transmits a message indicating that the artists identified by the names “John Smith” and “Billy Martin” have been selected for the client's job. Thus, these artists are sent a job request by the object manager 17, as described above.

In one exemplary embodiment, the object manager 17 implements a quick viewing tool that facilitates the client's review of the artist credentials. In this regard, the client has the option of selecting a quick view button 163. Upon such selection, the object manager 17 displays a page 172, referred to hereafter as the “quick view page.” The quick view page 172 displays more detailed information about at least one of the artists relative to the web page 150. Further, in one exemplary embodiment, the object manager 17 filters the information displayed in the quick view page 172 based on criteria specified by the client. For example, as described above, the server 18 may store samples of graphical objects previously created by the artist. Such samples may be categorized. Some exemplary categories include, but are not limited to, modeling, animation, concept, texturing, rigging, terrain, environments. However, other categories may be used in other embodiments.

In addition, the client may indicate that the job pertains to objects of a certain category. Such indication may be gleaned from the query submitted by the client or otherwise specified by the client. As an example, the client query may specify that only the names of artists having experience modeling objects within an identified category are to be returned. Based on the category indicated by the client, the object manager 17 includes within the quick view page 172 only samples 178 of the identified category and excludes samples of other categories. Thus, each displayed sample is in the category of interest to the client. In other embodiments, the client may establish the filtering parameters for controlling which types of artist information are displayed separately from the query. The quick view page 172 of FIG. 6 also displays additional information 180, such as textual information, describing attributes of the artist, such as performance scores, experience, skill level, services pricing, etc.

If the client wishes to approve the artist whose information is being displayed in the quick view page, the client can select a button 177 to indicate such acceptance. In response, the client system 12 transmits a message to the server 18 indicating that the artist has been selected for the current job. In response, the object manager 17 transmits a job request to such artist.

The quick view page 172 of FIG. 6 has forward and back arrows 181 and 182 that allow the client to navigate through the artists identified by the query. In this regard, in response to selection of the forward arrow 182, the quick view page 172 is refreshed with the information of the next artist in the list. In response to selection of the back arrow 181, the quick view page 172 is refreshed with the information of the previous artist in the list. Thus, the client can quickly navigate through filtered information for multiple artists, and the filtering may be based on client selections so that the client is likely to have a high degree of interest in the displayed information. In other examples, the filtering may be applied to other types of information. For example, the client may specify that textual information is to include certain categories of information (e.g., services pricing and performance scores) such that other information (e.g., location) of relatively little interest to the client is not displayed.

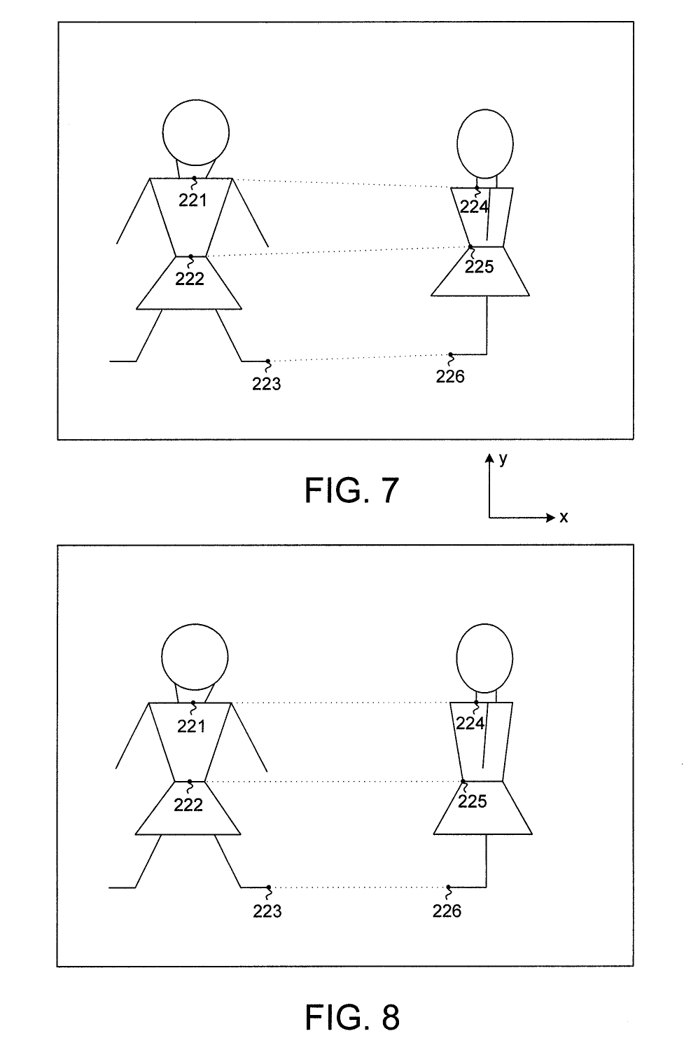

In one exemplary embodiment, the artist application 52 provides an alignment tool for helping the artist in creating graphical objects based on misaligned drawings. In this regard, as described above, an artist may be provided with images of an object to be drawn or modeled by the artist. Such images may be misaligned. For example, FIG. 7 shows an exemplary display rendered by an artist system 21. The display includes a front 2D perspective of a character and a 2D side view of the character. An artist may be asked to draw a 3D character or object (such as the character's skirt or other clothing) based on the 2D images. However, as shown by FIG. 7, the two images are misaligned. In this regard, points 221-223 respectively correspond to points 224-226. In this regard, relative to the object (i.e., the character), points 221 and 224 are at the same vertical position (in the y-direction). In this regard, points 221 and 224 are both at the boundary between the character's shoulder and the character's neck. Further, points 222 and 225 are at the same vertical position relative to the object. In this regard, points 222 and 225 are at the boundary between the character's skirt and the character's shirt. In addition, points 223 and 226 are at the same vertical position relative to the object. However, points 221 and 224 are not at the same vertical position within the display shown by FIG. 7, and points 222 and 225 are not at the same vertical position shown by FIG. 7. Further, points 223 and 226 are not at the same vertical position shown by FIG. 7. In this sense, the two perspectives are misaligned. Moreover, because of the misalignment, a reference line passing through corresponding points 221 and 224 is not parallel with a reference line passing through points 222 and 225 and a reference line passing through points 223 and 226.

The artist application 52 is configured to identify corresponding points of multiple images of the same object and to align such points. In aligning the points, the application 52 is configured to resize at least one of the images to accommodate the alignment of the corresponding points. Note that the corresponding points may be identified with the assistance of user input. For example, in FIG. 7, a user may utilize a mouse or other user input device to select points 221 and 224 (e.g., clicking point 221 and dragging to point 224) in order to identify these two points as being corresponding with one another. Similarly, the user may select points 222 and 225 such that these points are identified as corresponding, and the user may select points 223 and 226 to identify these points as corresponding. Once the corresponding points have been identified, the application 52 moves the points of at least one image such that each set of corresponding points is aligned (i.e., at the same vertical position). Thus, a reference line passing through corresponding points 221 and 224 is parallel with a reference line passing through corresponding points 222 and 225 and with a reference line passing through corresponding points 223 and 226.

For illustrative purposes, assume that the y-distance (i.e., the distance in the y-direction) from point 223 to point 222 is smaller than the y-distance from point 226 to pint 225. Further assume that, in aligning the two images of FIG. 7, the points 226 and 225 are moved closer together. In such an example, the character's legs and skirt of the side view are resized to accommodate such change. In this regard, the character's legs and skirt of the side view are compressed (made smaller), such that the y-distance of the legs and skirt in one perspective is equal to the y-distance of the legs and skirt in the other perspective. Accordingly, if the artist begins drawing an object, such as a skirt, based on the front perspective, then the size of the object should be consistent with the other perspective thereby facilitating the artist's use of the other perspective to help complete the object.

In one exemplary embodiment, a client can predefine categories of rules to be used for handling job information 33. Data 47, referred to hereafter as “job rules,” defining such rules can be stored at the server 18 or other location, such as at a client system 12. For each category, the job rules 47 may specify or indicate which artists may receive a set of job information 33 or a job request. As an example, assume that a client anticipates requesting jobs to be performed by artists in different categories. In this regard, assume that some jobs can be worked on by any artist in any country, some jobs can be worked on by artists only in the U.S., and some jobs can be worked on only by artists who have acquired a certain level of security clearance. The client may set up categories of rules that can be useful in defining job requests, and each category is assigned a unique identifier.

For example, assume that a client defines a category of rules, which is assigned an identifier of “Category 1,” and the rules of this category indicate that a job can be worked on by any artist. Assume that the user defines another category of rules, which is assigned an identifier of “Category 2,” and the rules of this category indicate that a job can be worked on by U.S. artists only. Further assume that the user defines another category of rules, which is assigned an identifier of “Category 3,” and the rules of this category indicate that a job can be worked on by artists who have acquired a certain level of security clearance.

In defining the job information 33 for a particular job request, the client may specify or otherwise indicate in the submitted job information 33 which artists can work on the job and, therefore, receive a job request. However, if the category of artists to be used is already defined by one of the categories of job rules 47, then the client may simply include the category identifier for the appropriate category. Using such category identifier, the object manager 17 is configured to consult the identified category of job rules 47 to determine how to restrict and/or form job requests.

As an example, if any artist can work on a particular job, the client submitting the job information 33 for such job may include the category identifier of Category 1 in the job information 33. Based on such category identifier, the object manager 17 is configured to define the job requests according to the identified category of rules. For example, in the instant case, the object manager 17 is aware that a job request for the current job can be sent to any user based on the job rules 47. However, if the job information 33 included an identifier of Category 2 rather than Category 1, then the object manager 17, based on the job rules 47, determines that job requests can only be sent to artists in the U.S. If the job information 33 included an identifier of Category 3 rather than Category 1 or 2, then the object manager 17, based on the job rules 47, determines that job requests can only be sent to artists who have acquired a certain security clearance. Thus, the object manager 17 based on the predefined job rules 47 controls which artists can access the job information and receive a particular job request.

Note that a category of job rules 47 can restrict access to job information and/or job requests based on any criteria. For example, one of the categories of rules may specify that only artists under a certain price or rate are to be solicited for a job. A category of rules may also specify a required skill or experience level. The use of predefined categories of rules facilitate the selection of artists that can work on a job or access the job information 33 for a job.

Note that job rules 47 may be stored at a client system 12 and used by the client application 82 in handling job information 33. For example, a client may generate a set of job information 33 for a job that is to be handled in-house (i.e., within the client's organization). One or more of the category of job rules may indicate that job information 33 is not to be communicated outside of the client's organization. Thus, if a set of job information 33 includes a category identifier for one such category, then the client application 82 is configured to refrain from sharing the job information 33 with the server 18.

In addition, if the job rules 47 are stored at a client system 12, it is unnecessary for the job information 33 transmitted to the server 18 to include the category identifier provided by the client. In this regard, based on the category identifier for a given set of job information 33, the client application 82 may consult the job rules 47 to determine how the job information 33 is to be handled and/or which artists can receive job requests. Rather than including the category identifier in the job information 33 transmitted to the server 18, the client application 82 may automatically define the set of transmitted job information 33 such that the security rules of the identified category are implemented. As an example, if the identified category indicates that a certain set of artists are to work on the job, rather than including the category identifier in the job information 33 transmitted to the server 18, the client application 82 may include the artist identifiers for such artists. The object manager 17 may then transmit job requests to the identified artists. Thus, the rules specified by the identified category are implemented without the job rules 47 being stored at the server 18 and without the category identifiers being transmitted to the server 18. In other embodiments, other techniques for implementing the rules of an identified category are possible.

An exemplary operation and use of the graphical object management system 10 will now be described below.

Initially, an artist uses an artist system 21 to register with the system 10 in order to become eligible to participate in the management service provided by the system 10. The artist system 21 communicates with the server 18 via the network 15 and provides the server 18 with various information. For example, the artist provides his or her name and address, and the artist provides information about the artist's services as a graphical artist. For example, the artist may provide information about his or her experience and information about his or her pricing, such as a billing rate. The artist also may upload graphical images of objects previously created by the artist. The object manager stores the provided information as part of the artist information 31 correlated with the artist. The object manager 17 may also require the artist to agree to certain terms and policies. For example, before registering the artist, the object manager 17 may require the artist to agree to keep information provided to the artist by the object manager 17, such as drawing or other types of information from client systems 12, confidential. During registration, the artist application 52 may be downloaded from the server 18 to the artist system 21.

After registering with the system 10, the artist is allowed to participate in projects managed by the system 10. The object manager 17 evaluates the artist's participation in such projects and assigns the artist a performance score indicative of the artist's quality of work, as determined by the object manager 17 or otherwise. For example, after completing a job for a client, the object manager 17 may request the client to evaluate the artist's performance. The object manager 17 may adjust the artist's performance score based on such feedback. The object manager 17 may also base the performance score on other factors, as is described in more detail above.

If desired, the object manager 17 may assign a pseudo-name to the artist which is to be used for communication between clients and the artist. For illustrative purposes, assume that the object manager 17 assigns the pseudo-name “Picasso” to the artist.

Assume that a client desires to find an artist to perform a particular job. As an example, assume that the client would like to find an artist to draw a 3D graphical object based on a 2D drawing of the object. Using a client system 12, the client submits a query to the server 18. The query includes various search criteria to find a suitable artist. For example, assume that the client would like to only use an artist located within a particular region and having a performance score above a certain threshold. Within the query, the client specifies the acceptable regions for the artist and the range of an acceptable performance score. For example, the range could be any performance score above a threshold specified in the search query.

In response, the object manager 17 searches through the artist information 31 to identify artists who satisfy the search query. The object manager 17 replies with a list of such artists. In the instant case, assume that Picasso satisfies the search query, and the name “Picasso” is included in the list. Note that for all communications with the client, the pseudo-name Picasso is used to identify the artist rather than the artist's real name, which could be stored at the server 18 as part of the artist information 31. Thus, no communication with the client includes the artist's real name or other information that could indicate the true identity of the artist to the client. In other embodiments, it is possible to use the client's real name or other identifying information if there is no desire to keep the identity of the artist from the client. If desired, pseudo-names of the client could be similarly used to keep the identity of the client from the artist.

In addition to communicating the name “Picasso” to the client, the object manager 17 also communicates portions of the artist information 31, such as information about the artist's skill level, performance score, and sample images of objects previously created by the artist. After reviewing Picasso's artist information 31, assume that the client selects Picasso as a suitable artist for working on the client's job. In response to such selection, the object manager 17 transmits to Picasso a job request describing the job. If Picasso is the only artist selected, then a job request is only sent to Picasso. However, if the client selects other suitable artists, then similar job requests are sent to the other artists. In such case, the first artist to reply with an acceptance is assigned the job (assuming that more than one artist is not to be assigned to the job). If x artists are to be assigned to the job, then the first x number of artists to accept the job are assigned the job. In other embodiments, other techniques for awarding the job are possible. In the instant example, assume that there is only one artist to be assigned to the job.

As indicated above, the job request includes various information about the job so that the artist can make an informed decision about accepting the job. For example, the job request may include the 2D image for which a 3D image is to be created. The job request may also indicate other information, such as an estimate of the amount of time that would be required to complete the job, the maximum that the client is willing to pay for completion of the job, deadlines for completing the work, etc. Such information may be specified by the client when submitting the query or at some other time. Portions of the information may also be specified by the object manager 17. For example, the object manager 17 may specify in the job request deadlines for completing certain tasks associated with the job. As a mere example, the client may specify a due date for completion of the graphical object, and the object manager 17 may specify a due for completion for a certain percentage (e.g., 50%) or percentages of the graphical object. In the current example, assume that the job request indicates that the object is to be 50% completed by September 1 and 100% completed by September 14.

Assume that Picasso accepts the job request and is assigned the job by the object manager 17. Using the artist application 52, Picasso begins creating the 3D graphical object similar to the 2D object included in the job request. As Picasso's work progresses, the client can review the 3D graphical object being created. Further, Picasso and the client may communicate with one another via the object manager 17, which forwards messages from Picasso to the client and from the client to Picasso. In addition, using the input and output devices 28 and 29 at the server 18 or otherwise, a user, such as an employee of the owner or operator of the server 18, may also monitor Picasso's progress in a manner similar to the client. Such a step is to give added oversight to Picasso's work in an effort to control and improve the quality of work provided to the client.

Once Picasso believes that the 3D graphical object is 50% complete, Picasso submits a notification of such event via the artist system 21. The object manager 17 retrieves the notification and, if desired, notifies a user, such as an employee of the owner or operator of the server 18. Such user may analyze the 3D graphical object. If the user identifies any issues, such as poor work quality or a completion percentage much less than 50%, the user may contact Picasso to try to resolve the issues or take other actions.

In addition, a notification is transmitted by the object manager 17 to the client informing him or her when Picasso has reached the 50% milestone. The client is requested to provide feedback within a certain time frame of such notification. For example, the client may be asked to assess the completion percentage of the 3D graphical object and provide a value indicative of the assessed completion percentage. Accordingly, the client may access the 3D graphical object stored at the server 18 and review it to determine a completion percentage. If a difference between the completion percentage assessed by the client and the expected completion percentage (i.e., 50% in this example) is greater than a threshold, then the object manager 17 detects a performance anomaly. In response, the object manager 17 notifies a user of the performance anomaly. For example, the object manager 17 may transmit a message to Picasso indicating that the client's assessment of the completion percentage is much different than that of Picasso. Alternatively, the object manager 17 may transmit such a notification to another user, such as an employee of the owner or operator of the server 18. In any event, the object manager 17 helps to discover a potential problem in the work of Picasso at a relatively early stage in the development process so that the potential problem can be remedied before completion.

Note that the object manager 17 may be configured to adjust Picasso's performance score based on the 50% deadline described above. For example, if Picasso submitted a notification that the 3D object is 50% after the deadline of September 1, then Picasso's performance score may be adjusted downward as a punishment for missing the deadline. Further, the extent that the score is adjusted may be based on the extent to which the deadline was missed. In addition, if Picasso submitted a notification that the 3D object is 50% complete prior to the deadline of September 1, then Picasso's performance score may be adjusted upward as a reward for meeting the deadline. In addition, the score may be adjusted based on feedback from the client. For example, if the client agrees that the object is 50% complete, then Picasso's performance score may be adjusted upward. However, if the client indicates that the object is less than 50% percent complete, then Picasso's performance score may be adjusted downward. In addition, the extent that the score is adjusted may be based on the extent to which Picasso missed the expected completion percentage of 50%. Also, the client may be asked to evaluate Picasso's performance in meeting the deadline and to provide a value indicative of such performance. The object manager 17 may then update Picasso's performance score based on such value. Picasso's performance score could be updated in other ways, if desired. Note that is assumed above that an upward adjustment of the performance score improves such score and a downward adjustment is detrimental to such score. However, in other embodiments, it is possible to control the performance score such that a lower score is better than a higher score or to control the performance score in some other way.

Once Picasso believes that the 3D graphical object is 100% complete, Picasso sends a notification to the server 18. A review of the 3D graphical object by the client and/or other users may occur in a manner similar to the review described above for the 50% deadline. Further, as described above for the 50% deadline, Picasso's performance score for the 100% deadline may be adjusted based on how well he met the deadline and/or completed the expected task. Once the client agrees that the object is 100% complete, final payment for the object is tendered. Such payment may occur via electronic payment to the object manager 17. A portion of such payment may be tendered to Picasso. For example, after securing funds from the client, the object manager 17 may make an electronic payment to Picasso. The remainder of the funds from the client may be kept by the owner or operator of the server 18 as a service fee for brokering the transaction between the client and the artist.

Note that the system 10 described above has been described in the context of managing the production of graphical objects. However, the system 10 may be similarly used for other purposes. In this regard, similar techniques may be used to help clients find third parties for performing various services in lieu of creating graphical objects. For example, a similar system 10 could be used to help publishers find authors for creating literary works rather than graphical objects. In another example, a similar system could be used to help clients find service providers or investor for the creation and/or publishing of video games, movies, or other media content. In yet other examples, the system 10 may be used to locate various service providers and to manage the services provided by such service providers.

Now, therefore, the following is claimed:

1. A graphical object management system, comprising:
memory for storing artist information indicative of graphical artists; and
an object manager configured to provide a client system with the artist information and to allow the client system to select an artist indicated by the artist information, the object manager further configured to receive a job request from the client system, the job request specifying a graphical object to be created by the selected artist, wherein the object manager is configured to transmit job information from the job request to an artist system associated with the selected artist, and wherein the object manager is remotely located from the client system and the artist system.

2. The system of claim 1, wherein the artist system has an artist application, the artist application configured to create the graphical object based on input from the selected artist, the artist application configured to automatically transmit graphical data defining the graphical object to the object manager, wherein the client system is configured to access the graphical object via the object manager.

3. The system of claim 2, wherein the artist application is configured to ensure that the graphical object is deleted from the artist system before closing.

4. The system of claim 1, wherein the object manager or the client system is configured to implement at least one security rule restricting a client's access to the graphical object, and wherein the object manager is configured to release the graphical object from the at least one security rule upon verifying payment tendered by the client.
